(19) United States
(12) Patent Application Publication
(10) Pub. No.: US 2026/0099771 A1
(43) Pub. Date: Apr. 9, 2026

(54) Systems and methods for training a multi-label classification model

(71) Applicant: Canva Pty Ltd, Surry Hills (AU)

(72) Inventors: Kerry Jayne HALUPKA, Melbourne (AU); Benjamin Phillip ALEXANDER, Southbank (AU)

(73) Assignee: Canva Pty Ltd, Surry Hills (AU)

(21) Appl. No.: 19/316,156

(22) Filed: Sep. 2, 2025

(30) Foreign Application Priority Data
Oct. 8, 2024 (AU) 2024227167

(51) Int. Cl. G06N 20/00

(52) U.S. Cl. CPC G06N 20/00

(57) ABSTRACT

A method, system and computer-readable medium for training a multi-label classification model to learn a new entity added to a dictionary of the multi-label classification model are disclosed. The method includes: identifying candidate training instances based on the new entity; generating a training record for each of the candidate training instances, where the training record includes the candidate training instance and the new entity as a new label; for each training record: adding existing entities from the dictionary, such that the training record includes a set of labels including the new label; and refining the set of labels to remove labels that are not related to the corresponding training instance. The method further includes training the multi-label classification model using the refined training records.

### CROSS REFERENCE TO RELATED APPLICATION

This application is a U.S. Non-Provisional application that claims priority to Australian Patent Application No. 2024227167, filed Oct. 8, 2024, which is hereby incorporated by reference in its entirety.

### TECHNICAL FIELD

Aspects of the present disclosure are directed to machine learning models and more particularly to systems and methods for generating and using training data to train a multi-label classification model.

### BACKGROUND

Multi-label classification is a type of supervised learning problem where each instance (data point) is associated with multiple labels simultaneously. Unlike traditional single-label classification, where each instance belongs to one and only one class, multi-label classification allows an instance to be assigned multiple classes or categories. For example, instead of labelling an image of a beach with a single label such as “beach”, it may be labelled with multiple labels such as “sand”, “sea”, and “sunset.”

Typically, training such multi-label classification models involves providing the model with a large training dataset (that includes instances of the data the model is supposed to handle once trained). For example, in case the multi-label classification model is designed to identify/classify objects on roads and notify drivers/vehicles of any potential dangers or obstacles on the road, the training data set includes images (typically from multiple different angles) of various types of objects/vehicles/infrastructure elements that might be encountered on a road along with labels of the objects in the images so that the neural network can learn to identify objects on the road in real time. Similarly, if the multi-label classification model is used to label images with “tags” or “concepts”, the training dataset includes images that are prelabelled with tags or concepts.

Often the multi-label classification model is trained by first generating an appropriate amount (such as hundreds of thousands or even millions of images). Subsequently, the images are labelled. In the case of autonomous vehicles, this labelling includes tagging each image with objects in the image (such as traffic signals, poles, pedestrians, cyclists, motor vehicles, etc) and in the case of tagging images, this labelling includes tagging each image with concepts that are relevant to the image (e.g., family, love, affection, children, etc.). Next, the labelled data is fed to the multi-label classification model, which is trained to estimate the labels (i.e., identify the objects or concepts in the examples above) in an image based on the content of the image. During the training process, an image is fed to the multi-label classification model and based on the weights of the model (which are updated during the training process), two or more labels from the many possible labels are selected. If the labels are inaccurate, the model changes its weightings to be more likely to produce the correct labels. This process is repeated numerous times with multiple images, until the model can correctly identify and label instances most of the time. It will be appreciated that the more the process is repeated and the more varied the training data set is, the more accurate the model will be.

Most techniques used for generating training data for training such models are labour-intensive in terms of generating and labelling training data sets. Further, it will be appreciated that the accuracy of the model is dependent on the accuracy of the person/program (classifier) that labels the images to begin with.

Thus, the challenges in implementing such models include generating and labelling large training data sets and validating the training data sets. Both are important as they are central to any artificial intelligence-based learning approach.

### SUMMARY

Described herein is a computer-implemented method for training a multi-label classification model to learn a new entity added to a dictionary of the multi-label classification model, the method comprising: identifying candidate training instances based on the new entity; generating a training record for each of the candidate training instances, where the training record includes the candidate training instance and the new entity; for each training record: adding one or more existing entities from the dictionary, such that the training record includes a set of entities including the new entity; and refining the set of entities to remove entities that are not related to the corresponding training instance; and training the multi-label classification model using the refined training records.

Also disclosed herein is a computer processing system including: a processing unit; and a non-transitory computer-readable storage medium storing instructions, which when executed by the processing unit, cause the processing unit to perform the above-described method.

Further still, disclosed herein a computer readable medium comprising instructions, which when executed by a processing unit of a computer processing system cause the computer processing system to perform the above-described method.

### BRIEF DESCRIPTION OF THE DRAWINGS

In the drawings:

FIG. 1 is a diagram depicting a networked environment in which various features of the present disclosure may be implemented.

FIG. 2 is a block diagram of a computer processing system configurable to perform various features of the present disclosure.

FIG. 3 is a flowchart depicting an example method for training a multi-label classification model.

FIG. 4 is a flowchart depicting an example method for identifying candidate design elements for a new entity added to a dictionary of the multi-label classification model according to some embodiments of the present disclosure.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth to provide a thorough understanding of the present invention. It will be apparent, however, that the present invention may be practiced without these specific details. In some instances, well-known structures and devices are shown in block diagram form to avoid unnecessary obscuring.

As described previously, generating pre-labelled instances of training data can be tedious and inaccurate using presently known techniques. Such known techniques face even more challenges when the number of classifications are diverse and numerous and/or when new classifications are added, and the training dataset has to be updated to include training records associated with the new classifications.

As used herein, the term dictionary refers to a collection of classification or entities that are available to a multi-label classification model to select one or more labels from. The term label refers to a classification or entity from the dictionary that has been added to a particular training record (during training) or an element that is supposed to be labelled (during implementation of the system). That is, a classification or entity in the dictionary becomes a label once it is associated with a training record or element. Until then, it is referred to as a dictionary entity in this disclosure.

Aspects of the present disclosure provide new systems and methods for automatically generating a large, diverse training dataset for new classifications/entities added to a dictionary of a multi-label classification system that can subsequently be used to train the multi-label classification system.

To do so, for any new dictionary entity added to a dictionary of a multi-label classification model, the systems and methods perform a search for candidate instances (e.g., in one or more databases) and label the identified candidate instances with the new dictionary entity. The systems and methods then add one or more current entities from the dictionary of the multi-label classification model to the candidate instances as applicable. This reduces the label sparsity of the training dataset. In some embodiments, adding one or more current dictionary entities may result in over-labelling of one or more candidate instances or in incorrectly labelling one or more candidate instances. To address this, one or more labels assigned to one or more candidate instances are automatically identified as being irrelevant to the one or more candidate instances and removed.

Thus, the presently disclosed systems and methods can automatically generate a new training dataset as new concepts/categories are added to the dictionary of a multi-label classification system, ensuring that the classification model remains relevant and accurate. In addition, the disclosed systems and methods ensure that both common and rare labels are adequately represented in the training data test (e.g., by adding current entities from the dictionary as labels and refining the labels) to improve the accuracy and robustness of the classification model as it is continuously trained. These systems and methods also mitigate bias in the dataset by targeting diverse representations of each dictionary entity.

In one example, aspects of the present disclosure are utilized for labelling images in the field of digital designs with tags or concepts. This may be useful for digital design applications and systems that allow users to generate digital designs, for example by allowing them to search for design elements using keywords.

It will be appreciated that this is merely used as an example technical field in which the presently disclosed systems and methods may be employed for description purposes and that the presently disclosed techniques can be used in other technical fields without departing from the scope of the present disclosure. For instance, the disclosed systems and methods may be utilized for labelling instances in fields such as medical imaging, e-commerce, and autonomous vehicles.

These and other aspects of the present disclosure will now be described with reference to the following figures.

### System

As described previously, the techniques disclosed herein are described in the context of a multi-label classification system that is configured to automatically generate two or more labels for any input design elements. In the context of the present disclosure, these operations relevantly include automatically labelling design elements such as images, videos, designs, and/or audio clips that can be subsequently used to train the multi-label classification system.

The presently disclosed system may take various forms. In the embodiments described herein, the system is described as a stand-alone platform (e.g. a single application or set of applications that run on a computer processing hardware and perform the techniques described herein without requiring client-side operations). The techniques described herein can, however, be performed (or be adapted to be performed) by a client-server type system (e.g. one or more client applications and one or more server applications that interoperate to perform the described techniques).

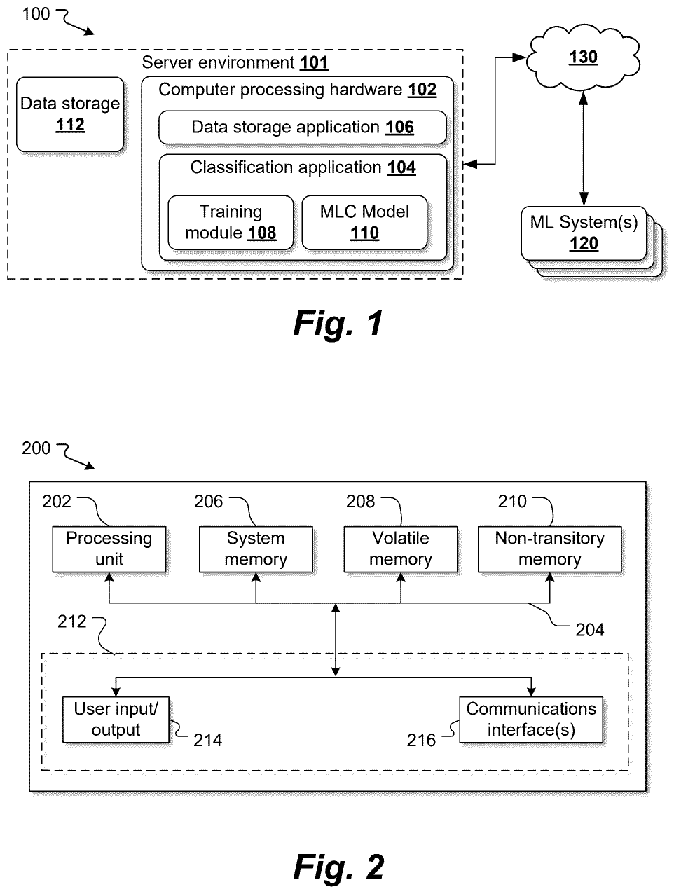

FIG. 1 depicts an example networked environment 100 in which various features of the present disclosure may be implemented. The networked environment 100 includes a server environment 101 and one or more ML systems 120, which operate together to perform the operations described herein. The systems 101 and 120 communicate with one another via one or more communication networks 130 (e.g., the Internet).

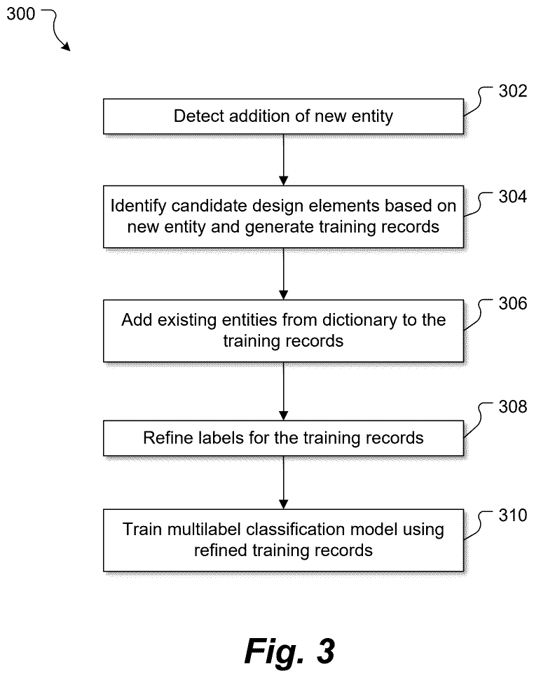

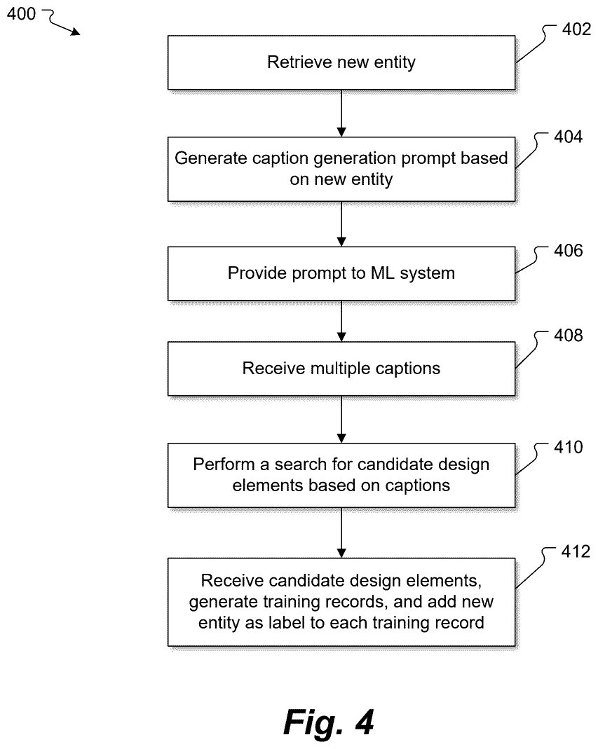

Generally speaking, the server environment 101 includes computer processing hardware 102 (discussed below) on which applications that perform the methods of FIGS. 3-4 execute. In the present example, the server environment 101 includes a classification application 104, and a data storage application 106.

The classification application 104 facilitates various functions related to automatically generating training datasets for use in training the multi-label classification system. This may include, for example, searching for and retrieving design elements, labelling the design elements with new dictionary entities, adding existing dictionary entities to the retrieved design elements as labels and refining the labels.

To provide this functionality, the classification application 104 includes a training module 108 and a multi-label classification model (MLC model) 110. The training module 108 is configured to generate training data and train the MLC model 110 based on the training data until the MLC model 110 can classify input design elements with multiple labels sufficiently accurately.

The MLC model 110 is trained to receive one or more input design elements and output two or more labels for the design elements that describe or in some ways are related to the content of the input design elements. Operations of these modules will be described in more detail later.

Although the MLC Model 110 is depicted as part of the classification application 104, in some embodiments, the MLC model 110 may be an independent application hosted by a different server environment.

The data storage application 106 executes to receive and process requests to persistently store and retrieve data relevant to the operations performed/services provided by the classification application 104. Data relevant to the operations performed/services provided by the classification application 104 may include, for example, design element data (e.g., design elements such as templates, videos, images, vector graphics, audio clips, etc., that can be used to create designs), vector representation data (e.g., vector representations of the design elements that may be stored along with identifiers of the corresponding design elements), and/or other data relevant to the operation of the server environment 101. In addition, the data includes training data required to train the MLC model 110. The training data includes multiple training instances. Each training instance includes a design element and two or more labels associated with the design element.

The data storage application 106 may, for example, be a relational database management application or an alternative application for storing and retrieving data from data storage 112. Data storage 112 may be any appropriate data storage device (or set of devices), for example one or more non-transitory computer readable storage devices such as hard disks, solid state drives, tape drives, or alternative computer readable storage devices.

In server environment 101, the classification application 104 persistently stores data to data storage 112 via the data storage application 106. In alternative implementations, however, the classification application 104 may be configured to directly interact with data storage devices such as 112 to store and retrieve data (in which case a separate data storage application 106 may not be needed). Furthermore, while a single data storage application 106 is described, server environment 101 may include multiple data storage applications. For example, one data storage application 106 may be used for design data, another for MLC training data, another for design element data and so forth. In this case, each data storage application 106 may interface with one or more shared data storage devices and/or one or more dedicated data storage devices, and each data storage application 106 may receive/respond to requests from various applications (including, for example classification application 104).

As noted, the classification application 104 runs on (or are executed by) computer processing hardware 102. Computer processing hardware 102 includes one or more computer processing systems. The precise number and nature of those systems will depend on the architecture of the server environment 101.

For example, in one implementation each classification application 104 may run on its own dedicated computer processing system. In another implementation, two or more classification applications 104 may run on a common/shared computer processing system. In a further implementation, server environment 101 is a scalable environment in which application instances (and the computer processing hardware 102—i.e. the specific computer processing systems required to run those instances) are commissioned and decommissioned according to demand—e.g., in a public or private cloud-type system. In this case, server environment 101 may simultaneously run multiple instances of each application (on one or multiple computer processing systems) as required. Where server environment 101 is a scalable system, it will include additional applications to those illustrated and described. As one example, the server environment 101 may include a load balancing application (not shown) which operates to determine demand, direct client traffic to the appropriate classification application instance 104 (where multiple classification applications 104 have been commissioned), trigger the commissioning of additional server environment applications (and/or computer processing systems to run those applications) if required to meet the current demand, and/or trigger the decommissioning of server environment applications (and computer processing systems) if they are not functioning correctly and/or are not required for current demand.

Communication between the applications and computer processing systems of the server environment 101 may be by any appropriate means, for example direct communication or networked communication over one or more local area networks, wide area networks, and/or public networks (with a secure logical overlay, such as a VPN, if required).

The one or more machine learning (ML) systems 120 host one or more ML models that may be configured to generate outputs based on input prompts. The ML systems 120 may include a multimodal system that is designed to process and understand information from multiple types of input data, such as text, images, audio, and sometimes even video. Examples of such multimodal systems include CLIP (Contrastive Language-Image Pretraining), DALL-E, GPT-40, ViT, etc.

Such multi-modal systems may be used to identify candidate design elements, suggest additional labels for the candidate design elements, and refine labels applied to such candidate design elements. It will be appreciated that in some embodiments the same multimodal system may be utilized for all these functions and in other embodiments, different multimodal ML systems may be utilized for different functions. For example, CLIP may be utilized to identify candidate images, GPT-40 may be utilized to refine labels added to the candidate design elements, and another multimodal ML system may be utilized for adding additional labels to the candidate design elements. Operations of these multimodal models will be described later.

Further, the ML systems 120 may include one or more natural language processing (NLP) systems. Such NLP systems may be configured to receive an input prompt (e.g., a caption generation prompt) and generate multiple captions for a label based on the input prompt.

In some embodiments, the NLP system may be a large language model (LLM) that is trained as a general-purpose ML model that can be used to generate different types of text-based outputs. In the present case, if a general-purpose ML model is used, it is additionally trained to perform specific tasks. For example, the general-purpose ML model may be trained to generate captions from a prompt. In other embodiments, the ML system 120 may be a more specific model that is trained to generate the outputs described above.

Further still, in some examples, the one or more ML systems 120 may be associated with and owned by the same party that operates the server environment 101. In this case, the ML system 120 may be part of the server environment 101. In other examples, the ML system 120 may be owned or operated by a third party that is independent to the party that owns or operates the server environment 101. Examples of third party LLMs include OpenAI's ChatGPT, and Google's Bard.

The present disclosure describes various operations that are performed by applications of the server environment 101 and/or the ML systems 120. Generally speaking, however, operations described as being performed by a particular application (e.g., training module 108 and/or the ML systems 120) could be performed by one or more alternative applications, and/or operations described as being performed by multiple separate applications (e.g., training module 108 and the ML systems 120) could in some instances be performed by a single application.

Turning to FIG. 2, a block diagram depicting hardware components of a computer processing system 200 is provided. The computer processing hardware 102 of FIG. 1 may be a computer processing system such as 200 (though alternative hardware architectures are possible).

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and usable by (either in a shared or dedicated manner) system 200.

Through a communications bus 204 the processing unit 202 is in data communication with one or more machine readable storage devices (also referred to as memory devices). Computer readable instructions and/or data which are executed by the processing unit 202 to control operation of the processing system 200 are stored on one more such storage devices. In this example system 200 includes a system memory 206 (e.g. a BIOS), volatile memory 208 (e.g. random-access memory such as one or more DRAM modules), and non-transitory memory 210 (e.g. one or more hard disk or solid-state drives).

System 200 also includes one or more interfaces, indicated generally by 212, via which system 200 interfaces with various devices and/or networks. Other devices may be integral with system 200 or may be separate. Where a device is separate from system 200, connection between the device and system 200 may be via wired or wireless hardware and communication protocols and may be a direct or an indirect (e.g. networked) connection.

Generally speaking, and depending on the system in question, devices to which system 200 connects-whether by wired or wireless means-include one or more input devices to allow data to be input into/received by system 200 and one or more output devices to allow data to be output by system 200.

As an example, system 200 may be remotely operable from another computing device via a communication network. Such a system may not itself need/require further peripherals such as a display, keyboard, cursor control device etc. (though may nonetheless be connectable to such devices via appropriate ports). Alternative types of computer processing systems, with additional/alternative input and output devices, are possible.

System 200 also includes one or more communications interfaces 216 for communication with a network. Via the communications interface(s) 216, system 200 can communicate data to and receive data from other networked systems and/or devices.

System 200 stores or has access to computer applications (also referred to as software or programs)—i.e. computer readable instructions and data which, when executed by the processing unit 202, configure system 200 to receive, process, and output data. Instructions and data can be stored on non-transitory machine-readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, in FIG. 1 computer processing hardware 102 includes and executes application classification application 104.

In some cases, part or all of a given computer-implemented method will be performed by system 200 itself, while in other cases processing may be performed by other devices in data communication with system 200.

It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

### Data Structure for Training Data

The following section describes data structures employed by the classification application 104 and in particular the training module 108 to store training data. The data structures and fields described are provided by way of example. Depending on the implementation, additional, fewer, or alternative fields may be used. Further, the fields described in respect of a given data structure may be stored in one or more alternative data structures (e.g. across multiple linked data structures). Further, although tables are used to illustrate the data structures, the relevant fields/information may be stored in any appropriate format/structure.

Data in respect of a training instance may be stored in various formats. An example data format that is used throughout this disclosure will now be described. Alternative design data formats (storing alternative training data attributes) are, however, possible, and the processing described herein can be adapted for alternative formats.

In the present context, data in respect of a given training instance is stored in a training record. Generally speaking, a training record defines certain attributes and includes an identifier of a design element and two or more labels associated with the design element. Depending on the task the training data is used for, the labels may vary. For example, if the training data is used by a multi-label classification system in a design application, the labels may describe various concepts associated with the design element. Alternatively, if the training data is used by a multi-label classification system in an autonomous vehicle system, the labels may describe the various objects identified in the associated design element (which would be an image in this example). Each snapshot includes a snapshot identifier.

In the present example, the format of each design record is a device independent format comprising a set of key-value pairs. To assist with understanding, a partial example of a raw training record is as follows:

TABLE A
an example training record

| Key/field | Example |
|---|---|
| Training | ID: “abc123”, |
| datapoint ID | |
| Design element | ID: “34283” |
| ID | |
| Design element | https://media-public.com/MAA-xXX-Xxx/1.jpg |
| URL | |
| Labels | [“PcZi”, “4pVN”, “Zbj3”] |

### Example Methods

Various methods and processes for generating and using training data will now be described. In particular, FIG. 3 illustrates an example process for training a multi-label classification system (e.g., MLC model 110) and FIG. 4 illustrates an example method for identifying candidate design elements for a new label.

FIG. 3 illustrates an example method 300 for training the MLC model 110 to output one or more labels in response to receiving an input design element.

The method 300 commences when a new entity is added to a dictionary of the MLC model 110 (at step 302). In some embodiments, the MLC model 110 may already be trained to classify design elements based on a set of dictionary entities. This set of existing entities is referred to as the dictionary of the MLC model 110. Over time, new entities may be added to the dictionary, e.g., because new concepts and categories emerge over time.

At step 304, candidate training data instances (e.g., candidate design elements in the present example) are identified based on the new entity. Further, training records are generated based on the identified candidate design elements and the new entity is associated with these training records as a new label. This step will be described in detail with reference to FIG. 4.

At step 306, existing entities from the MLC model's dictionary are added to the training records as additional labels. Training the MLC model 110 with training records that only include the new label (i.e., sparsely labelled training records) may impact the performance and generalization ability of the MLC model 110. For example, the model 110 may become biased towards labels that appear more frequently in the training records, it may struggle to learn meaningful features from the training records, and/or it may fail to learn relationships between different labels (e.g., some labels might frequently co-occur in training records). Further, the model 110 may fail to correctly predict combinations of labels that often appear together, leading to incorrect or incomplete label predictions.

To address these issues, additional entities (from the MLC model's dictionary) are added to the training records as additional labels.

This can be done in a few different ways. In one example, a pre-trained zero-shot multimodal model (such as CLIP or GPT40) that can classify design elements can be used. The multimodal model analyses each training record and identifies one or more entities or concepts that match the training record. In case a model like CLIP is utilized that is not a generative model, the existing entities from the MLC model's dictionary are provided to the multimodal model and it selects one or more of the existing entities that match the corresponding design element.

Typically, multimodal models have a predefined threshold value that is used to determine whether a label should be assigned to an input or not. After processing an input, these models generally output a probability score for each entity in their dictionary, indicating the likelihood that the entity is relevant to the input. These probability scores are then compared to the threshold probability value. If the probability score for an entity is higher than or equal to the threshold probability value, a corresponding label is assigned to the input. Otherwise, if the probability score of an entity is less than the threshold probability value, a corresponding label is not assigned. Typically, the threshold probability value is set relatively high (e.g., about 0.8-0.9) such that the model assigns labels associated with highly relevant entities. However, in the present case, the threshold probability level is set lower (e.g., about 0.5) to increase the number of labels assigned to a candidate design element.

In some embodiment, the multimodal model utilized at this step is the MLC model 110 (before it has been trained on the new dictionary entity). In other cases, the multimodal model utilized at this step may be a different model.

If a zero-shot multimodal model such as GPT40 is utilized, the training module 108 initially generates a label prompt.

In some examples, the label prompt includes configuration data and prompt data. Prompt data includes the design elements from the training records and keywords associated with the existing entities from the MLC model's dictionary. The configuration data may include a brief description of the task (e.g., for each of the given design elements return a subset of the keywords that match the corresponding design elements), parameters for the task (e.g., output format, relevancy of the results, rules, etc.), and one or more training examples of prompt data and the output the multimodal model is expected to generate.

The table B below shows examples of configuration data that can be used.

TABLE B
Example label prompt configuration data

| | |
|---|---|
| Description | Return a list of keywords from the <SET OF |
| of task: | KEYWORDS> that are relevant to each <DESIGN |
| | ELEMENT> |
| Parameters: | Make sure the keywords are inclusive |
| | The <SET OF KEYWORDS> will be provided as a list of |
| | keywords IDS and associated keywords (with primary |
| | meanings in brackets). |
| | Return the list of keywords that are relevant. Do not be |
| | strict on relevance threshold for each keyword. If the |
| | keywords can be associated with the corresponding design |
| | element, include it. |
| Examples: | Example 1 |
| | For an image of a glyph of a bidirectional arrow with both |
| | ends pointed in opposite directions, with the following |
| | proposed keywords: |
| | [‘FV5A: pointer (ui element/programming reference)’, |
| | ‘3BAp: down (direction)’, ‘60oX: navigate (direction or |
| | travel course)’, ‘BIYr: direction (course or path)’, ‘QJgr: |
| | directional (movement orientation)’, ‘pBn5: design (verb)’, |
| | ‘VF07: up (direction)’, ‘Mz2q: illustrations (artistic visual |
| | representation)’9M2n: decrease (reduction)’, ‘rWWg: |
| | drawing (image creation)’, ‘Q3-t: increase (growth)’, |
| | ‘dAZq: arrow (symbolic direction indicator)’, ‘buJD: point |
| | (location)’, ‘_yIV: symbol (conventional representation)’, |
| | ‘Z7Hs: curve (geometric entity)’, ‘fhE2: sketch (rough |
| | drawing)’, ‘RAbA: road sign (directions indicator)’, ‘o4yM: |
| | glyph (graphical symbol or character)’] |
| | Desired output |
| | [‘FV5A: pointer (ui element/programming reference)’, |
| | ‘3BAp: down (direction)’, ‘BIYr: direction (course or |
| | path)’, ‘QJgr: directional (movement orientation)’, ‘VF07: |
| | up (direction)’, ‘9M2n: decrease (reduction)’, ‘Q3-t: |
| | increase (growth)’, ‘dAZq: arrow (symbolic direction |
| | indicator)’, ‘RAbA: road sign (directions indicator)’] |

It will be appreciated that the configuration data may include many alternative components. For example, the configuration data may be (or include) a single pre-assembled template prompt—e.g. a string that includes all the relevant set text components.

The training module 108 combines the prompt data and the configuration data to generate the label prompt. Once the label prompt is generated, the training module 108 communicates the label prompt to the ML system 120. By way of the configuration data, the ML system 120 is cued to generate the list of keywords. For example, based on the example configuration data shown in table B, the ML system 120 may be cued to generate a list of keywords suitable for each of the design elements. The ML system 120 outputs the keywords in accordance with the corresponding prompt data.

The output by the ML system 120 is received by the training module 108 as a string of output text, referred to as a completion. The training module 108 processes the completion, which may include analysing the completion to identify the respective keywords for each design element. For example, the training module 108 may parse or process the output text to identify a string of text following the appearance of “,” as defined by the output format of the completion in the configuration data. Additionally or alternatively, text content may be identified according to line breaks, carriage returns and/or special characters as may be defined in the configuration data. Many alternative parsing, text analysis and processing techniques are also possible to identify the text elements in the completion.

The training module 108 stores the keywords identified for each design element in its corresponding training record.

In still other embodiments, all the existing entities in the dictionary of the MLC model 110 are added to each training record—in which case a multimodal model is not required at this step. However, this technique may cause the next step to be more computationally intense if the number of entities in the dictionary are high.

At step 308, the labels of the training records are refined. In some cases, step 306 may over-label the candidate design elements-such that the training records may include labels that may not be relevant to the corresponding design elements and/or may be tangentially relevant. Accordingly, at this step, the labels are analysed along with corresponding design elements to determine whether they are accurate/relevant or not. If any inaccurate/irrelevant labels are identified, they are removed at this step.

This step may be performed in various suitable ways. In one embodiment, a multimodal model can be utilized. In one example, if the design element is an image, a multimodal model such as CLIP may be utilized. If the design element is a video clip, a video-based multimodal model may be utilized. Similarly, if the design element is an audio clip, an audio-based multimodal model may be utilized. In any event, the labels and the corresponding design element for each training record are provided to the multimodal model, which generates vector representations for the design element and the text labels. These vector representations are embedded in a common embedding space such that the model can directly compare the similarity of the design element to the text labels.

In some examples, a threshold similarity value may be utilized. If the similarity score determined for any of the text labels in comparison to the design element fall below this threshold similarity value, the corresponding text labels are removed. Otherwise, if the similarity score determined for a text label in comparison to the design element is higher than the threshold similarity value, the corresponding text label is retained.

In another embodiment, a multi-modal model may be utilized together with an LLM in a pipeline to visually assess the text labels. The multi-modal model, such as CLIP, can be used to generate a textual description of the design element. This textual description of the design element can then be compared with the corresponding text labels, e.g., by the LLM. The LLM may be provided a suitable prompt—e.g., “for the given text description of a design element determine whether the corresponding text labels accurately represent the content described in the text description” along with the text description and the text labels. The prompt may further include configuration data that defines the task, the parameters for the task, and/or includes a few shot examples of expected results.

The LLM can then evaluate whether the text labels match the text description. If the LLM determines that one or more of the sets of text labels do not match the text description (e.g., if a text label is “dog” and the textual description indicates that the candidate design element includes a cat), the LLM can determine that the one or more of the set of text labels are not relevant. The LLM may output a subset of text labels from the original set of text labels that the LLM determines to be relevant to the textual description.

In some embodiments, a different multimodal model such as GPT40 may be utilized, which is a combination of a multimodal model and an LLM. Such multimodal models are capable of processing and integrating information from multiple modalities or sources of data. The modalities may be distinct types of data such as text, images, vector graphics, audio, and video.

Such a multimodal model may be provided with a refinement prompt that includes the design elements and all the labels assigned to each design element and may be prompted to determine whether the assigned labels are relevant to the design element or not. The prompt may include parameters that define the level of accuracy required (e.g., direct or contextual), whether the text labels describe elements in the design element and/or abstract concepts that may not necessarily be present in the design element but are evoked based on an understanding of the design element, etc.

The table C below shows examples of configuration data that can be used.

TABLE C
Example refinement configuration data

| | |
|---|---|
| Description | Return a list of highly relevant keywords from the <SET |
| of task: | OF KEYWORDS> associated with each <DESIGN |
| | ELEMENT> |
| Parameters: | Make sure the returned keywords are highly relevant |
| | The <SET OF KEYWORDS> will be provided as a list of |
| | keywords IDS and associated keywords (with primary |
| | meanings in brackets). |
| | Focus on each keyword one by one, considering how |
| | relevant it is. Be strict on the relevance threshold for |
| | each keyword, if a user would not expect to see the |
| | corresponding <design element> in response to searching |
| | for the keyword then the keyword should be rejected. |
| Examples: | Example 1 |
| | For an image of a glyph of a bidirectional arrow with both |
| | ends pointed in opposite directions, with the following |
| | proposed keywords: |
| | [‘FV5A: pointer (ui element/programming reference)’, |
| | ‘3BAp: down (direction)’, ‘60oX: navigate (direction or |
| | travel course)’, ‘BIYr: direction (course or path)’, ‘QJgr: |
| | directional (movement orientation)’, ‘pBn5: design (verb)’, |
| | ‘VF07: up (direction)’, ‘Mz2q: illustrations (artistic visual |
| | representation)’9M2n: decrease (reduction)’, ‘rWWg: |
| | drawing (image creation)’, ‘Q3-t: increase (growth)’, |
| | ‘dAZq: arrow (symbolic direction indicator)’, ‘buJD: point |
| | (location)’, ‘_yIV: symbol (conventional representation)’, |
| | ‘Z7Hs: curve (geometric entity)’, ‘fhE2: sketch (rough |
| | drawing)’, ‘RAbA: road sign (directions indicator)’, ‘o4yM: |
| | glyph (graphical symbol or character)’] |
| | Desired output |
| | [‘FV5A: pointer (ui element/programming reference)’, |
| | ‘3BAp: down (direction)’, ‘BIYr: direction (course or |
| | path)’, ‘QJgr: directional (movement orientation)’, ‘VF07: |
| | up (direction)’, ‘9M2n: decrease (reduction)’, ‘Q3-t: |
| | increase (growth)’, ‘dAZq: arrow (symbolic direction |
| | indicator)’, ‘o4yM: glyph (graphical symbol or character)’] |

It will be appreciated that the configuration data may include many alternative components. For example, the configuration data may be (or include) a single pre-assembled template prompt—e.g. a string that includes all the relevant set text components.

The training module 108 combines the prompt data and the configuration data to generate the refinement prompt. Once the refinement prompt is generated, the training module 108 communicates the label prompt to the ML system 120. By way of the configuration data, the ML system 120 is cued to refine the list of keywords associated with each design element. For example, based on the example configuration data shown in table C, the ML system 120 may be cued to generate a list of keywords suitable for each of the design elements. The ML system 120 outputs the keywords in accordance with the corresponding prompt data.

The training module 108 receives the output from the ML system 120 as a string of output text, referred to as a completion. The training module 108 processes the completion, which may include analysing the completion to identify the respective refined keywords for each design element. For example, the training module 108 may parse or process the output text to identify a string of text following the appearance of “,” as defined by the output format of the completion in the configuration data. Additionally or alternatively, text content may be identified according to line breaks, carriage returns and/or special characters as may be defined in the configuration data. Many alternative parsing, text analysis and processing techniques are also possible to identify the text elements in the completion.

Once the output from any of these techniques is received by the training module 108, the training module 108 updates the corresponding training records. For example, if an output indicates that one or more text labels associated with a design element are incorrect or inappropriate, the training module 108 may automatically delete such text labels from the corresponding training record.

At step 310, once training records are refined, they are provided to the MLC model 110 to train the MLC model 110 to identify the new entity and to be able to label input design elements with the new entity (if the new entity is suitable for the input design element). The MLC model 110 may be trained using suitable techniques, such as passing it a portion of the training records such that the MLC model 110 can update its internal weights in light of the new training records and then using another portion of the training records for validation—i.e., to check whether the MLC model 110 has sufficiently learnt to identify the new entity and apply it to design elements. In the validation step, the MLC model 110 may be provided some of the training records with the new entity and some training records that do not include the new entity to check whether the MLC model 110 can identify the difference between the new entity and other existing entities in the dictionary.

It will be appreciated that method 300 is described based on the assumption that a single new label is added to the dictionary of the multi-label classification system at step 302. However, this need not be the case always. In some cases, multiple labels may be added to the dictionary at the same time or method 300 may be performed once a threshold number of new labels have been added to the dictionary. In any such cases, candidate design elements may be identified for each of the new labels in step 304. If the same candidate design elements are retrieved for more than one new label (e.g., if the design element satisfies more than one new label), the two or more labels may be added to the training records for such design elements and duplicate design elements may be discarded before proceeding to step 306.

FIG. 4 illustrates an example method 400 for identifying candidate design elements for a new entity added to the MLC model's dictionary and generating training records. The method commences at step 402 where the new entity is retrieved from the MLC model's dictionary.

Generally, when performing a search for candidate design elements for a given entity, the returned candidate design elements may be specific and similar. For example, if an entity is “lemon” and design elements corresponding to this entity are searched for in a database, the top search results are likely to be design elements where “lemon” is prominent. The top search results are unlikely to include design elements that include lemon trees or lemon pies. If the MLC model were trained with such specific training examples for an entity, it may end up being a specific classification system that is unable to accurately label diverse input design elements.

To address this, the new entity is initially converted into several captions. The captions capture varying meaning and usages of the entity in practice. Continuing with the “lemon” example, the captions are meant to capture lemon trees, lemons on trees, lemons in meal dishes, as a garnish on drinks, and much more. These captions are then used to perform searches for design elements. The captions may be generated in various suitable ways. In one approach, an ML system 120 (e.g., an LLM) is utilized to generate the captions.

Accordingly, at step 404, the training module 108 utilizes the new entity to generate a caption generation prompt.

In some examples, the caption generation prompt includes configuration data and prompt data. The configuration data may include a brief description of the task (e.g., to generate multiple captions based on the entity, keywords and a definition of the entity), parameters for the task (e.g., output format, tone of the output, rules, etc.), and one or more training examples of entities and the text content the ML system 120 is expected to generate based on the input prompts. In some examples, the task may specify the number of captions required to be generated.

The table D below shows examples of configuration data that can be used.

TABLE D
Example configuration data

| | |
|---|---|
| Description | Generate x descriptions for design elements for a given |
| of task: | WORD, where the WORD is represented in the design |
| | elements. |
| Parameters: | Each description should be a string of keywords that can be |
| | used to perform a search for one or more media items such |
| | as images, videos or audio clips. |
| | Generate diverse descriptions based on different usages, |
| | meanings, and/or contexts in which the label may be used. |
| | Return descriptions that would be keyword tagged with the |
| | WORD if the design element were to exist. |
| | Each caption should be separated from the next by “$$$” |
| Examples: | Input: Lemon (A lemon is a bright yellow fruit of the citrus |
| | species that has a sour taste and is commonly used in |
| | cooking and baking.) |
| | Output: |
| | 1. A lemon hanging on a tree |
| | 2. Sliced lemons on a plate |
| | 3. A lemon tree with lemons |
| | 4. A lemon pie |
| | 5. A slice of lemon in a drink glass |
| | 6. A lemon being zested . . . |
| | 7. A lemonade stand with lemons displayed |

It will be appreciated that the configuration data may include many alternative components. For example, the configuration data may be (or include) a single pre-assembled template prompt—e.g. a string that includes all the relevant set text components.

Returning to method step 404, once the training module 108 receives the new entity, it concatenates the entity with the configuration data to generate the caption generation prompt. In some embodiments, the training module 108 identifies various definitions of the entity and adds these definitions along with the entity name to the prompt.

At step 406, once the caption generation prompt is generated, the training module 108 communicates the caption prompt to the ML system 120.

By way of the configuration data, the ML system 120 is cued to generate captions (e.g., a predetermined number if specified in the configuration data or an arbitrary number if not specified) based, in part, on the entity and the parameters of the configuration data. For example, based on the example configuration data shown in table B, the ML system 120 may be cued to generate different types of captions having 4-5 words covering different concepts associated with the entity. The ML system 120 outputs the captions in accordance with the format specified in the configuration data.

At step 408, the training module 108 receives the captions output by the ML system 120 as a completion. The training module 108 processes the completion, which may include analysing the completion to identify respective individual captions.

At step 410, the training module 108 performs a search for candidate design elements using the captions. This may be performed in various suitable ways. As design elements (e.g., images, videos, audio clips) are typically in a different modality (e.g., visual or audio) from text-based queries, there is a need to first align these modalities. This may be done, e.g., by using a multimodal model that embed the design elements and the text-based queries in the same multidimensional embedding space.

There are various pre-trained models that can understand and relate media elements and text. Such models can understand and generate associations between media elements and text without needing explicit task-specific training. One such multimodal model that can understand and generate associations between images and text is CLIP or Contrastive Language-Image Pretraining model. Other models include residual networks (RES-Net), vision transformer (ViT), etc.

Similarly, for video type media items, a multimodal model may be utilized that performs the task of identifying what a video represents and understands associations between video items and text. The multimodal model may convert the video into a series of frames or images and feed these to a video classification model. The multimodal model may be configured to analyse each image or frame in the video to determine the content of the image/frame and analyse the spatio-temporal relationship between adjacent frames to recognize the actions in a video (e.g., rising sun, setting sun, person doing pushups, etc.). In one example, the multimodal model generates embeddings for videos that represent the actions being performed in the video along with the objects displayed in the video.

For audio media items, a multimodal model may be utilized that is configured to identify and classify what the audio represents. For example, the multimodal model may be configured to determine whether the audio is a song (and which song), is a noise (such as rain, clapping, birds chirping), or some other type of sound. The model may take audio waveforms as input and make predictions as to what the audio represents. In one example, the multimodal model may also generate an embedding for the audio item that represents what the audio item is. An example multimodal model may be VGGish, a deep learning model developed by Google® for audio feature extraction.

In any case, the multimodal model(s) are trained such that they can represent a sufficient amount of relevant information about the design element in the embedding and embed corresponding text in the same embedding space as the corresponding design element. For instance, the image multimodal model may be trained by feeding an appropriate number (hundreds of thousands if not millions) of labelled images (i.e., images and their textual description). The textual descriptions may be embedded into numerical representations using techniques such as word embeddings. The images may be pre-processed by dividing them into smaller patches or tiles. Each patch is then passed through a convolutional neural network of the embedding model to extract visual features. Both the textual embeddings and the visual features extracted from the images may be projected into a shared embedding space. The embedding model is trained using contrastive learning-embeddings of matching image-text pairs are encouraged to be closer together in the embedding space, while embeddings of non-matching pairs are pushed further apart. This encourages the model to learn embeddings that capture semantic similarities between images and their associated text.

The video and audio multimodal models can be similarly trained by providing them with a large number of labelled video and audio files, respectively. Training of multimodal models is known in the art and is not described in more detail here.

In some embodiments, the design elements (e.g., images, video clips and/or audio clips stored in the data storage 112) are provided to the corresponding multimodal model to be embedded in the embedding space. The vector representations generated by one or more of these models is returned to the classification application 104, which stores the vector representations along with unique identifiers of the corresponding design elements in the data storage 112.

At step 410, the captions generated by the ML system 120 are provided to the one or more multimodal models-depending on the types of candidate design elements and the types of multimodal models used. The multimodal model receives the captions, generates a vector representation for each caption and embeds it in the common embedding space. It then identifies one or more design elements (e.g., images, videos, and/or audio clips) that match each caption. To do so, the multimodal model may compute a similarity score (e.g., cosine similarity) between the vector representation of the caption and the vector representations of the pre-embedded design elements and retrieve vector representations of one or more design elements that have the highest similarity score.

In some embodiments, the captions may be provided independently, and the model may output the vector representation(s) of the closest matching design element(s) for each caption. As described previously, the data storage 112 includes a database that stores design element identifiers and their corresponding vector representations. The training module 108 may perform a lookup in this database with the vector representation(s) to retrieve the design element identifier(s) associated with the vector representation(s) output by the model. The design element identifier(s) identified for each caption may be stored in a temporary table.

Once design element identifier(s) are identified for all the captions and stored in the temporary table, the training module 108 may inspect the temporary table to identify duplicates (e.g., if the same design elements were identified for two or more captions). If any duplicates are found, they are removed from the temporary table.

In such embodiments, where candidate design elements are identified for each caption independently, if the captions are different, the vector representations of the closest matching design elements may come from different locations in the embedding space. As such, the diversity of the design elements may be high. However, there is a likelihood that some of the design elements are only tangentially related to the new label.

In other embodiments, the captions may be provided independently, but the multimodal model may average the vector representations of all the captions to generate a mean vector representation or embedding. This mean embedding may then be utilized to identify and output a predetermined number of media items (e.g., 50, 100, 200) that have the most similar vector representations to the mean embedding.

In such embodiments, the output design elements would likely not include any duplicates. Additionally, as a single text embedding (i.e., mean embedding) is utilized, the diversity of the identified candidate design elements using this method may be lower. However, the identified candidate design elements are more likely to be relevant to the label.

In yet another embodiment, the captions may first be clustered, e.g., using k-cluster method, into a suitable number of clusters (e.g., 5-10 clusters). The multimodal model may then average the vector representations of all the captions in a given cluster to generate mean vector representations for each cluster. These mean embeddings may then be utilized to identify and output a predetermined number of media items that have the most similar vector representations to the mean embedding of each cluster.

Such embodiments may provide more diverse design elements than the single mean vector embodiment and more relevant design elements than the independent embodiment.

Depending on the diversity and/or relevance requirements of the MLC model 110, any one of these techniques can be utilized at step 410.

At step 412, the training module 108 generates training records based on the temporary table. Each training record includes the identifier of the design element and the label it is associated with. Once the training records are generated, the temporary table may be cleared.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. These different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A method for training a multi-label classification model to learn a new entity added to a dictionary of the multi-label classification model, the method comprising:
identifying one or more candidate training instances based on the new entity;
generating a training record for each of the one or more candidate training instances, where the training record includes the candidate training instance and the new entity as a new label;
for each training record:
adding one or more existing entities from the dictionary, such that the training record includes a set of labels including the new label; and
refining the set of labels to remove labels that are not related to the corresponding training instance; and
training the multi-label classification model using the refined training records.

2. The method of claim 1, wherein identifying the candidate training instances comprises:
generating a plurality of captions based on the new entity, the plurality of captions capturing varying meaning and usages of the entity in practice; and
performing a search for candidate training instances in a database of instances using the plurality of captions.

3. The method of claim 2, wherein generating the plurality of captions comprises:
generating a caption generation prompt based on the new entity;
communicating the caption generation prompt to a large language model; and
receiving the plurality of captions from the large language model.

4. The method of claim 2, wherein performing the search comprises:
generating vector representations of the instances in the database and embedding the vector representations in an embedding space;
generating vector representations of each caption of the plurality of captions and embedding the vector representations of the plurality of captions in the same embedding space; and
for each caption of the plurality of captions, identifying one or more closest matching instances based on a distance between the vector representation of the caption and the vector representations of the instances.

5. The method of claim 4 further comprising:
inspecting the one or more closest matching instances for the plurality of captions to identify duplicate instances and remove the duplicate instance.

6. The method of claim 2, wherein performing the search comprises:
generating vector representations of the instances in the database and embedding the vector representations in an embedding space;
generating vector representations of each caption of the plurality of captions;
generating a mean vector representation based on an average of the vector representations of each caption of the plurality of captions;
embedding the mean vector representation in the same embedding space; and
identifying a predetermined number of closest matching instances based on a distance between the mean vector representation and the vector representations of the instances.

7. The method of claim 2, wherein performing the search comprises:
generating vector representations of the instances in the database and embedding the vector representations in an embedding space;
generating vector representations of each caption of the plurality of captions;
clustering the vector representations of the plurality of captions into a predetermined number of clusters;
generating a mean vector representation based on an average of the vector representations in each cluster;
embedding the mean vector representations for each cluster in the same embedding space; and
identifying a predetermined number of closest matching instances for each cluster based on a distance between the mean vector representation of the cluster and the vector representations of the instances.

8. The method of claim 1, wherein adding existing entities from the dictionary to each training record comprises:
providing each candidate training instance to a multimodal model that is trained on the existing entities from the dictionary, the multimodal model trained to determine labels relevant to a training instance based on analysis of the training instance; and
receiving from the multimodal model, one or more labels associated with each candidate training instance.

9. The method of claim 8, wherein a threshold probability value of the multimodal model is set to a predetermined threshold probability value that is a lower value than normal to increase a number of labels output by the multimodal model for each candidate training instance.

10. The method of claim 1, wherein adding existing entities from the dictionary to each training record comprises:
providing each candidate training instance and at least a subset of the existing entities in the dictionary to a multimodal model along with a prompt, the prompt configuring the multimodal model to compare the subset of the existing entities with each training instance to identify one or more existing entities from the subset of the existing entities that substantially match each training instance; and
receiving the one or more existing entities from the multimodal model that match each training instance.

11. The method of claim 1, wherein refining the set of labels to remove labels that are not related to the corresponding training instance comprises:
providing the set of labels and the training instance to a multimodal model, the multimodal model:
generating vector representations for the set of labels and the training instance;
embedding the generated vector representations in a common embedding space;
calculating similarity scores between the vector representations associated with the set of labels with the vector representation of the training instance;
determining whether a label is relevant to the training instance based on the calculated similarity score being equal to or greater than a threshold similarity score;
determining whether a label is irrelevant to the training instance based on the calculated similarity score being lower than a threshold similarity score; and
discarding the labels determined to be irrelevant.

12. The method of claim 1, wherein refining the set of labels to remove labels that are not related to the corresponding training instance comprises:
providing the training instance to a multimodal model, the multimodal model generating a textual description of the training instance;
providing the textual description and the set of labels to a large language model along with a prompt, the prompt configuring the large language model to compare the set of labels with the textual description to determine whether each label in the set of labels matches the textual description or not; and
receiving a subset of the set of labels from the large language model that match the textual description.

13. The method of claim 1, wherein refining the set of labels to remove labels that are not related to the corresponding training instance comprises:
providing the training instance and the set of labels to a multimodal model along with a prompt, the prompt configuring the multimodal model to compare the set of labels with the training instance to determine whether each label in the set of labels matches the training instance or not; and
receiving a subset of the set of labels from the multimodal model that match the training instance.

14. A computer processing system including:
a processing unit; and
a non-transitory computer-readable storage medium storing instructions, which when executed by the processing unit, cause the processing unit to:
identify candidate training instances based on the new entity;
generate a training record for each of the candidate training instances, where the training record includes the candidate training instance and the new entity as a new label;
for each training record:
add one or more existing entities from the dictionary, such that the training record includes a set of labels including the new label; and
refine the set of labels to remove labels that are not related to the corresponding training instance; and
train the multi-label classification model using the refined training records.

15. The computer processing system of claim 14, wherein identifying the candidate training instances comprises:
generating a plurality of captions based on the new entity, the plurality of captions capturing varying meaning and usages of the entity in practice; and
performing a search for candidate training instances in a database of instances using the plurality of captions.

16. The computer processing system of claim 15, wherein performing the search comprises:
generating vector representations of the instances in the database and embedding the vector representations in an embedding space;
generating vector representations of each caption of the plurality of captions and embedding the vector representations of the plurality of captions in the same embedding space;
for each caption of the plurality of captions, identifying one or more closest matching instances based on a distance between the vector representation of the caption and the vector representations of the instances; and
inspecting the one or more closest matching instances for the plurality of captions to identify duplicate instances and remove the duplicate instance.

17. The computer processing system of claim 15, wherein performing the search comprises:
generating vector representations of the instances in the database and embedding the vector representations in an embedding space;
generating vector representations of each caption of the plurality of captions;
generating a mean vector representation based on an average of the vector representations of each caption of the plurality of captions;
embedding the mean vector representation in the same embedding space; and
identifying a predetermined number of closest matching instances based on a distance between the mean vector representation and the vector representations of the instances.

18. The computer processing system of claim 15, wherein performing the search comprises:
generating vector representations of the instances in the database and embedding the vector representations in an embedding space;
generating vector representations of each caption of the plurality of captions;
clustering the vector representations of the plurality of captions into a predetermined number of clusters;
generating a mean vector representation based on an average of the vector representations in each cluster;
embedding the mean vector representations for each cluster in the same embedding space; and
identifying a predetermined number of closest matching instances for each cluster based on a distance between the mean vector representation of the cluster and the vector representations of the instances.

19. The computer processing system of claim 14, wherein refining the set of labels to remove labels that are not related to the corresponding training instance comprises:
providing the set of labels and the training instance to a multimodal model, the multimodal model:
generating vector representations for the set of labels and the training instance;
embedding the generated vector representations in a common embedding space;
calculating similarity scores between the vector representations associated with the set of labels with the vector representation of the training instance;
determining whether a label is relevant to the training instance based on the calculated similarity score being equal to or greater than a threshold similarity score;
determining whether a label is irrelevant to the training instance based on the calculated similarity score being lower than a threshold similarity score; and
discarding the labels determined to be irrelevant.

20. The computer processing system of claim 14, wherein refining the set of labels to remove labels that are not related to the corresponding training instance comprises:
providing the training instance to a multimodal model, the multimodal model generating a textual description of the training instance;
providing the textual description and the set of labels to a large language model along with a prompt, the prompt configuring the large language model to compare the set of labels with the textual description to determine whether each label in the set of labels matches the textual description or not;
receiving a subset of the set of labels from the large language model that match the textual description.
